(19) United States
(12) Patent Application Publication
(10) Pub. No.: US 2025/0020273 A1
(43) Pub. Date: Jan. 16, 2025

(54) Load-Bearing Structure with a Clamp

(71) Applicant: Eagle Fan, Chu-Pei City (TW)

(72) Inventor: Eagle Fan, Chu-Pei City (TW)

(21) Appl. No.: 18/765,371

(22) Filed: Jul. 8, 2024

(30) Foreign Application Priority Data
Jul. 14, 2023 (CN) 2218517214

(51) Int. Cl. F16M 13/02

(52) U.S. Cl. CPC F16M 13/022

(57) ABSTRACT

A load-bearing structure and method of manufacture are provided and include: a clamping unit for clamping to a place to be fixed to and a load-bearing unit rotatably connected to the clamping unit for carrying items or allowing items to be hung on; the clamping unit further including a shell having a fixed clamp arm located at one end and protruding from the shell; a linkage component, disposed in the shell, for driving a movable clamp arm to move along the shell; and a lever member, located on a top surface of the fixed clamp arm and pivotally connected to the linkage component in the shell, for enabling the linkage component to control the clamping or loosening of the movable clamp arm and the fixed clamp arm. As such, the present invention allows versatile usages while clamping to a fixed place.

### TECHNICAL FIELD

The present invention relates generally to a load-bearing structure with a clamp, and more particularly, to a load-bearing structure with a clamp that can provide a variety of different usage modes to meet different needs.

### BACKGROUND

For people who like to hear all the details in the music, or get higher quality sound from music streaming, over-ear headphones are better than the small, lightweight in-ear headphones. Because over-ear headphones are good at filtering out ambient noises, giving them better sound quality and better bass, and covering the ears with soft earmuffs. On the other hand, the earplug of in-ear headphones to be inserted into the ear canal can create a certain discomfort caused by a foreign body sensation.

However, the over-ear headphones are large in size. Considering the frequent use and the convenience of storage, a hanger structure is generally used for hanging the over-ear headphones. The hanger structure usually has an iron hook for hanging the over-ear headphones. The iron hook is used to fix the hanger structure on the wall and can only be used in one direction. The earphones and earphone cables are hung on the iron hook at the same time, which looks messy and unsightly, as the hanger cannot be rotated and adjusted conveniently so that the usage is limited to certain places, resulting in the low practicality. In addition, if the hanger structure is only used for hanging over-ear headphones, the practicality of such product will be relatively reduced. The present invention is disclosed based on the principle to expand the practicality by matching different accessories for different uses, which will also bring great convenience to the user.

### SUMMARY

A primary objective of the present invention is to provide a load-bearing structure with a clamp, which uses a clamping unit in the structure to increase the clamping tightness at the place to be fixed, and a load-bearing unit able to adjust the angle for use. The load-bearing unit carries various items or can be hung hereto. In addition, different accessories can be installed to increase the number of hanging items or allow different items to be placed.

In order to achieve the above objective, the present invention is a load-bearing structure with a clamp, which includes: a clamping unit and a load-bearing unit; the clamping unit further comprising a shell, being a hollow shell and having a fixed clamp arm located at one end of the shell and protruding from the shell; a movable clamp arm, able to move along a side wall of the shell, so that the movable clamp arm able to move towards or away from the fixed clamp arm; a linkage component, disposed in the shell, for driving the movable clamp arm to move along the shell; and a lever member, located on a top surface of the fixed clamp arm and pivotally connected to the linkage component in the shell; when the lever member being flipped, the linkage component driving the movable clamp arm to move linearly; when the lever member being pressed down against the top surface of the fixed clamp arm, the lever member dragging the linkage component to move linearly so as to shorten the distance between the movable clamp arm and the fixed clamp arm; the load-bearing unit having an end portion, and the end portion being rotatably connected to one end of the shell away from the fixed clamp arm, the load-bearing unit is used to carry items or allow items to be hung on.

In a preferred embodiment, the load-bearing unit is a long hollow shell, and the end portion is located at one end of the long shell of the load-bearing unit and protrudes from the load-bearing unit.

In a preferred embodiment, the load-bearing unit is further provided with an extension hook; a side wall of the load-bearing unit has an opening at the end portion, and the extension hook is inserted into the load-bearing unit through the opening; the extension hook is partially pulled out to protrude from the end side wall when in use without detaching from the load-bearing unit.

In a preferred embodiment, the linkage component comprises a screw rod and a moving member installed at the screw rod; the moving member is installed in the shell and is limited to linear movement; when the screw rod rotates, the moving member is driven to move; the movable clamp arm is engaged to the moving member, the moving member drives the movable clamp arm toward or away from the fixed clamp arm; the screw rod extends through the fixed clamp arm to the outside, and the exposed section of the screw rod is pivotally connected with the lever member.

In a preferred embodiment, the moving member is a rectangular frame, and a screw nut is fixed, and the screw nut is connected to the screw rod; the frame also has two long through grooves, and a part of the long grooves has a concave slot.

In a preferred embodiment, a side wall of the movable clamp arm has at least two guide pieces, and the side wall of the shell has two longitudinal guide grooves, and the two guide pieces penetrate into the shell through the guide grooves and are inserted into the long grooves of the moving member.

In a preferred embodiment, the guide piece has an elastic latch piece at a middle position, and the elastic latch piece penetrates into the shell through the guide groove, and the elastic latch piece is engaged to the slot of the moving member; when the moving member moves, the movable clamp arm also moves synchronously.

In a preferred embodiment, the lever member is pivotally connected to the screw rod, the centerline of the pivot joint is perpendicular to the centerline of the screw rod, and the lever member has a first contact wall and a second contact wall perpendicular to each other, the distance between the first contact wall and the pivot axis is less than the distance between the second contact wall and the pivot axis; to adjust the position of the moving member, pull the lever member up to stand upright and the first contact wall is in contact with the fixed clamp arm, at this point, when the lever member rotates, the screw rod also rotates synchronously; when the lever member is pulled downward and the second contact wall is in contact with the fixed clamp arm, the entire linkage component will be pulled up for a small distance, thereby shortening the distance between the movable clamp arm and the fixed clamp arm.

In a preferred embodiment, the shell is provided with a recessed first docking groove in the longitudinal direction of two corresponding side walls, and at least one stopper is provided in the first docking groove.

In a preferred embodiment, the end portion is provided with a second docking groove in the longitudinal direction of the two corresponding side walls, and after the position of the end portion is adjusted, the position of the second docking groove can correspond to the position of the first docking groove.

Compared with the known technology, the load-bearing structure with a clamp of the present invention has a rotatable connection between the clamping unit and the load-bearing unit, which helps the load-bearing unit to adjust the angle and facilitates hanging items. In addition, the clamping unit can enhance the clamping tightness so that it will not loosen after clamping on a table or a place to be fixed, thus preventing the loaded items from falling. In addition, the load-bearing structure with a clamp can also be equipped with different accessories, such as auxiliary hangers, cup holders, etc., thereby increasing the number of items that can be hung and the types of items that can be loaded to meet the different needs of users.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a three-dimensional schematic view of the present invention;

FIG. 2 is a three-dimensional schematic view of the present invention from another angle;

FIG. 3 is a partial cross-sectional schematic view of the internal structure of the present invention;

FIG. 4 is an exploded schematic view of components of the present invention;

FIG. 5A is a side view of the clamping unit of the present invention in an adjusting clamping state;

FIG. 5B is a side view of the clamping unit of the present invention in a clamped state;

FIG. 6 is a perspective view of another usage mode of the present invention;

FIG. 7A is an exploded view of the present invention with an auxiliary hanger;

FIG. 7B is a perspective view of the present invention with an auxiliary hanger;

FIG. 8A is an exploded view of the present invention with a cup holder;

FIG. 8B is a perspective view of the present invention with a cup holder;

FIG. 9A is an exploded view of the present invention with a hands-free support;

FIG. 9B is a perspective view of the present invention with a hands-free support;

FIG. 9C is a schematic view of the present invention installing a hands-free support for position adjustment;

FIG. 9D is an exploded view of the installation of a handsfree stand and a wireless charging head for the present invention;

FIG. 9E is a schematic of the installation of a handsfree stand and another usage mode of the present invention;

FIG. 10 is a perspective view of another clamping usage of the present invention;

FIG. 11 is a perspective view of the cup holder installed in FIG. 10;

FIG. 12A is a perspective view of the first usage mode of another embodiment of the present invention;

FIG. 12B is a perspective view of the second usage mode of another embodiment of the present invention.

### DETAILED DESCRIPTION

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

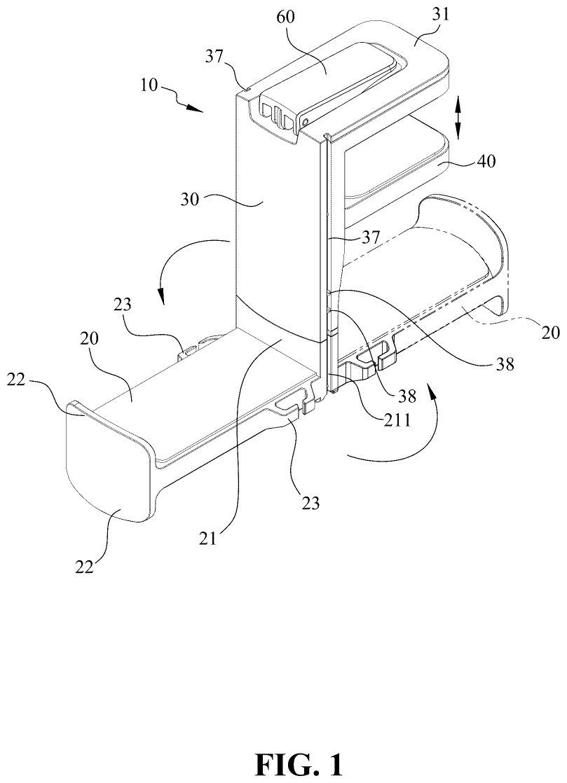

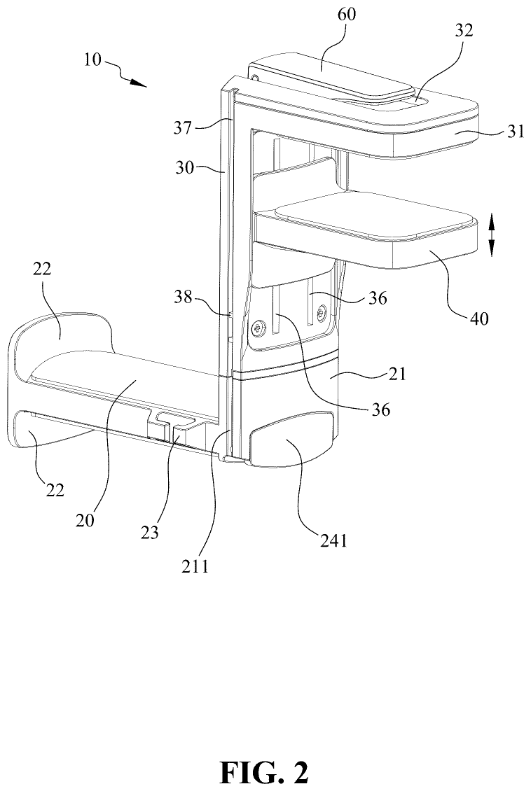

FIGS. 1 and 2 are three-dimensional schematic views of the present invention from different angles. The load-bearing structure with a clamp of the present invention includes a clamping unit 10 and a load-bearing unit 20. The clamping unit 10 is used to clamp onto a plate-like object with a thickness, such as a table, a flange or a rod of a platform, etc. The load-bearing unit 20 is rotatably connected to the clamping unit 10, whereby the clamping unit 10 can clamp at the desired fixed location. The load-bearing unit 20 can be rotated and adjusted to an appropriate position, so that the items can be hung on for the load-bearing unit 20 to meet different usage requirements.

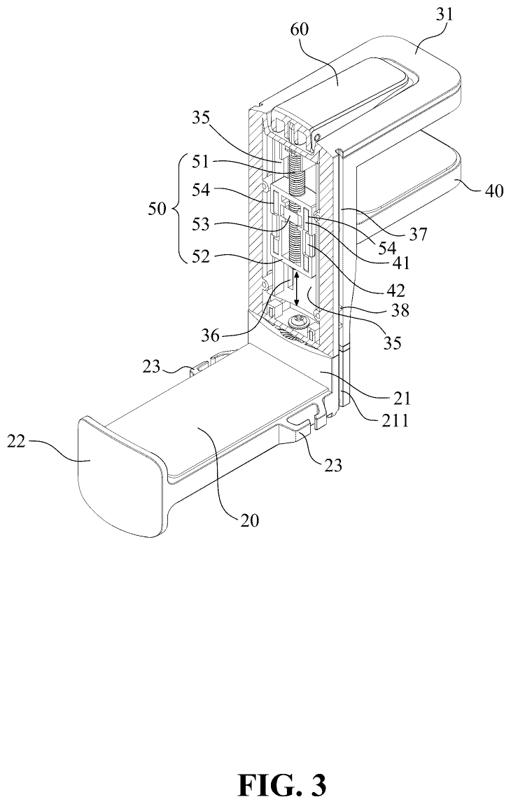

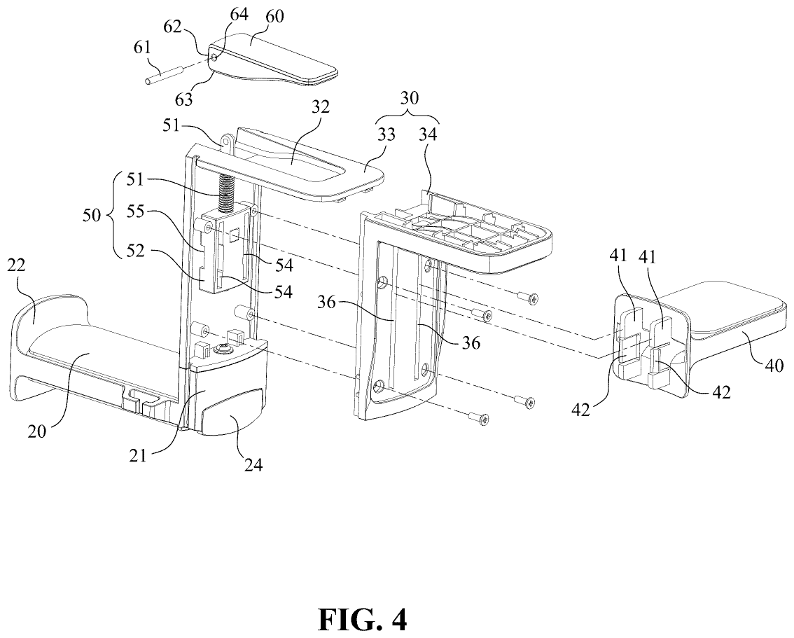

First, an explanation will be given on how to use the overall structure. FIGS. 3 and 4 together:

The clamping unit 10 includes a shell 30, a movable clamp arm 40, a linkage component 50 and a lever member 60. The shell 30 is a hollow, flat and upright shell, with a fixed clamp arm 31 protruding from the top, so that the overall body of the shell 30 is in an inverted L shape. The top of the fixing clamp arm 31 also has a recessed area 32 for the lever member 60 to be disposed therein. The movable clamp arm 40 can move along the vertical side wall of the shell 30 so that the movable clamp arm 40 can move towards or away from the fixed clamp arm 31. As such, the movable clamp arm 40 and the fixed clamp arm 31 achieve clamping and loosening from the clamping. The linkage component 50 is disposed in the shell 30 and is responsible for driving the movable clamp arm 40 to move linearly. In the present embodiment, the linkage component 50 includes a screw rod 51 and a moving member 52 that can move linearly when the screw rod 51 rotates. The screw rod 51 extends upward through the fixed clamp arm 31. The end of the screw rod 51 exposed from the fixed clamp arm 31 is pivotally connected to the lever member 60 in a direction perpendicular to the centerline of the screw rod 51. When the lever member 60 rotates upright, the screw rod 51 will be rotated, which will cause the moving member 52 to drive the movable clamp arm 40 to move to achieve the function of clamping or loosening. When the lever member 60 is pressed down against the top surface of the fixed clamp arm 31, the position of the lever member 60 is fixed so that the screw rod 51 cannot be rotated. However, when the lever member 60 is pressed down to lie flat, the linkage component 50 will be affected to produce a slight displacement, thereby shortening the distance between the fixed clamp arm 31 and the movable clamp arm 40, thereby increasing the tightness of the clamping between the fixed clamp arm 31 and the movable clamp arm 40, which is also the focus of the present design.

Next, each component of the clamping unit 10 will be described in more detail:

As shown in FIG. 4, the shell 30 is a hollow inverted L-shaped shell formed by combining a first L-shaped shell 33 and a second L-shaped shell 34. The shell 30 is mainly used to accommodate the linkage component 50. As shown in FIG. 3, a cavity 35 is formed inside the shell 30, and the cavity 35 limits the moving member 52 to only longitudinal linear movement. In addition, the second L-shaped shell 34 forms at least one guide groove 36 penetrating through the vertical side wall. The guide groove 36 is connected with the cavity 35, and the guide groove 36 is to enable the movable clamp arm 40 to move smoothly. In addition, the top surface of the shell 30 has a concave recessed area 32. The recessed area 32 matches the shape of the lever member 60, so that the lever member 60 can be stored therein when not in use, thereby reducing the volume of the protrusion from the top surface of the fixed clamp arm 31. Moreover, the shell 30 forms a first docking groove 37 in the longitudinal direction of the two narrower side walls. The first docking groove 37 has at least one stopper 38 inside. The structure of the first docking groove 37 and the stopper 38 are provided so that different accessories can be installed here. The usage of the mechanism will be described in detail in the following paragraphs.

The main function of the linkage component 50 is to drive the movable clamp arm 40 to move linearly. In the present embodiment, the linkage component 50 includes the screw rod 51 and the moving member 52 that is rotated by the screw rod 51 and can move linearly. The screw rod 51 is a rod with external threads on the surface. The moving member 52 has a screw hole inside and can be connected with the screw rod 51. The moving member 52 can be of many different shapes, and is not limited to the shape of the embodiments of the present invention. In the present embodiment, the moving member 52 is a rectangular frame, and a nut 53 is fixed to the frame. The nut 53 is mainly connected to the screw rod 51. As shown in FIGS. 3 and 4, the frame of the moving member 52 also has two penetrating long grooves 54. The long grooves 54 are partially shaped into an outwardly enlarging slot 55. The long grooves 54 and the slots 55 are for connecting with the movable clamp arm 40. In addition, the screw rod 51 penetrates and protrudes from the top surface of the fixed clamp arm 31. The screw rod 51 can be rotated but will not detach from the shell 30. When the screw rod 51 rotates, the moving member 52 is limited in the cavity 35, so that the moving member 52 can only move linearly.

In order to enable the movable clamp arm 40 to linearly move smoothly on the side wall of the shell 30, the side wall of the movable clamp arm 40 also has at least two guide pieces 41, and the guide pieces 41 protrude toward the direction of the shell 30. As shown in FIGS. 2 and 4, the side wall of the shell 30 has two penetrating guide grooves 36, and the movable clamp arm 40 is inserted into the corresponding guide groove 36 through the guide piece 41 to ensure that the movable clamp arm 40 can move smoothly along the shell 30, but the best state is that the guide piece 41 is also inserted into the slot 54 of the moving member 52. In addition, the guide piece 41 has an elastic latch piece 42 at the middle position. The end of the elastic latch piece 42 has a barb shape. The elastic latch piece 42 can be caught in the slot 55 of the moving member 52 (as shown in FIG. 3), the movable clamp arm 40 and the moving member 52 are engaged together. As such, when the moving member 52 moves, the movable clamp arm 40 can also move synchronously.

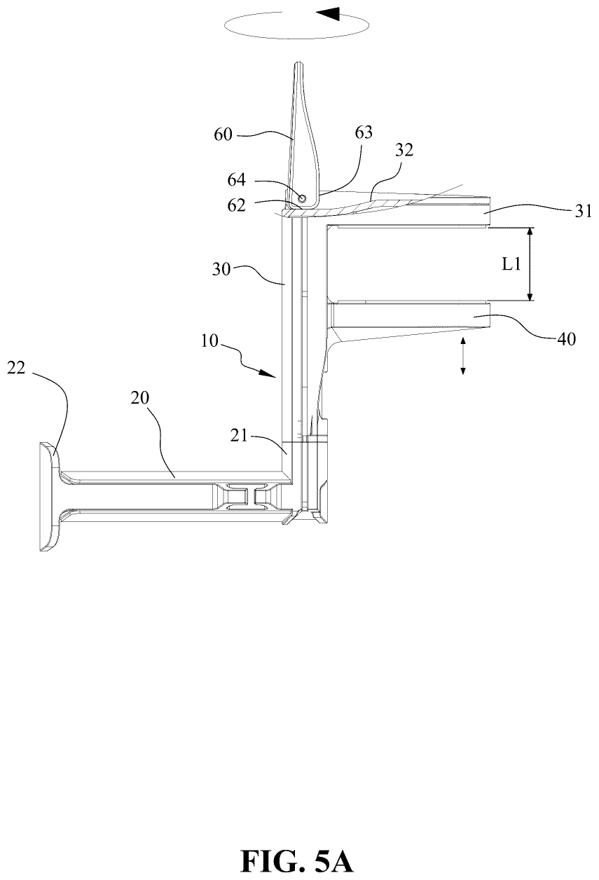

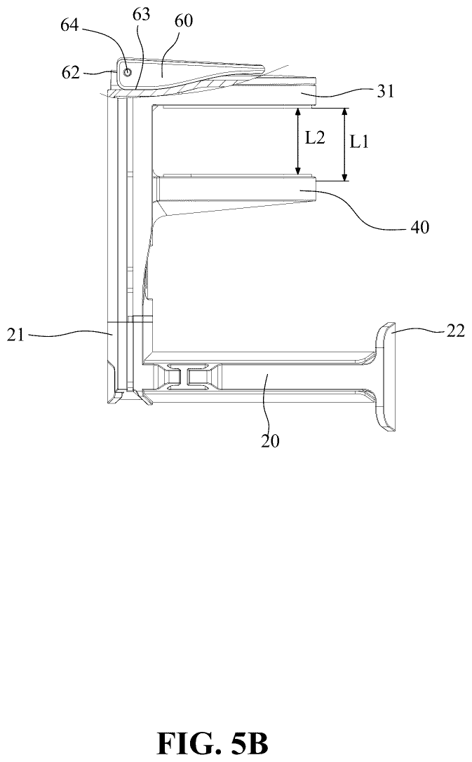

As shown in FIG. 4, the lever member 60 is pivotally connected to the screw rod 51 by a shaft 61, and the centerline of the shaft 61 used for the pivot connection is perpendicular to the centerline of the screw rod 51. The lever member 60 has a first contact wall 62 and a second contact wall 63 that are perpendicular to each other adjacent to the pivot axis 64. The connection between the first contact wall 62 and the second contact wall 63 is an arc surface. The special feature of the present invention is that the distance between the first contact wall 62 and the pivot axis 64 is smaller than the distance between the second contact wall 63 and the pivot axis 64. Therefore, in order to adjust the position of the moving member 52 as shown in FIG. 5A, the lever member 60 is first pulled up into an upright position, and the first contact wall 62 contacts the top surface of the fixed clamp arm 31; that is, the first contact wall 62 contacts the recessed area 32 on the top surface. At this time, the lever member 60 rotates the screw rod 51 to rotate synchronously, thereby driving the movable clamp arm 40 toward or away from the fixed clamp arm 31 to achieve the function of clamping or loosening. After adjustment, there is a preliminary distance L1 between the movable clamp arm 40 and the fixed clamp arm 31. As shown in FIG. 5B, the lever member 60 is then pulled downward. When the second contact wall 63 contacts the top surface of the fixing clamp arm 31, except that the screw rod 51 can no longer be rotated for fixing purposes, because the distance between the second contact wall 63 and the pivot axis 64 is greater than the distance between the first contact wall 62 and the pivot axis 64, the entire linkage assembly 50 will be pulled up by a preset distance. Therefore, the movable clamp arm 40 is in contact with the pivot axis 64. The original preliminary distance L1 between the fixed clamp arms 31 will be reduced to the clamping distance L2. Since L2 is smaller than L1, the clamping force of the movable clamp arm 40 and the fixed clamp arm 31 can be increased, so that it is not easy to loosen when clamping tightly. This is the special feature of the present invention. In addition, the movable clamp arm 40 and the fixed clamp arm 31 are also provided with soft pads or sponges on the surfaces facing each other to increase the friction force of clamping and satisfy the amount of deformation that may occur in clamping.

Next, the load-bearing unit 20 will be described in detail, as shown in FIGS. 1 and 2:

The load-bearing unit 20 is a laterally hollow elongated shell, with an upwardly extending protrusion end portion 21 at one end, and the end portion 21 is rotatably connected to an end of the shell 30 away from the fixed clamp arm 31. The connection means is to use screws to lock the two parts so that they are rotatable with respect to each other, but cannot be separated. In addition, elastic and movable teeth can be provided at the joints as docking members to ensure that they can still be fixed after being adjusted to various angle positions. The load-bearing unit 20 also has a stopper 22 at one end away from the end portion 21. The stopper 22 protrudes from the top and bottom surfaces of the load-bearing unit 20 to prevent the hanging objects from slipping. In addition, the top surface and the bottom surface of the load-bearing unit 20 can be curved to facilitate hanging of over-ear headphones. The load-bearing unit 20 also has at least a wire clamp 23. The wire clamp 23 is C-shaped and is located on the side wall of the load-bearing unit 20. The wire clamp 23 is used for hooking, hanging, or clamping the wires of the earphones to avoid loose wires. In addition, a second docking groove 211 is formed in the longitudinal direction of the two corresponding narrower side walls of the end portion 21. When the end portion 21 is adjusted to a corresponding position with the shell 30, the second docking groove 211 is also connected with the first docking groove 37, which is also used to install different accessories, and will be described in the following.

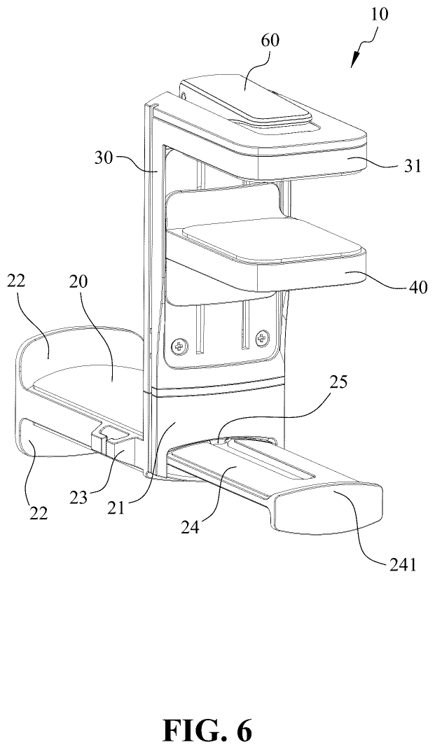

As shown in FIG. 6, the side wall of the load-bearing unit 20 is also provided with an extension hook 24. The load-bearing unit 20 has an opening 25 on the side wall where the end portion 21 is located, through which the extension hook 24 can be inserted into the hollow shell of the load-bearing unit 20. The extension hook 24 has a protruding arc stopper 241 at one end away from the end portion 21. The purpose of the arc stopper 241 is also to prevent the hanging objects from slipping. As shown in FIG. 2, when not in use, the extension hook 24 is inserted into the load-bearing unit 20, leaving only the arc stopper 241 exposed. The surrounding area of the arc stopper 241 is also connected to the side wall of the end portion 21, making the overall appearance simple and aesthetically pleasing. As shown in FIG. 6, when in use, the extension hook 24 can be pulled out and protrudes from the side of the end portion 21, but cannot be detached from the load-bearing unit 20. The invention uses the extension hook 24 to provide another place for hanging items, thereby increasing the usage of the present invention.

The load-bearing structure with a clamp of the present invention has many different ways of use. Moreover, with the use of different accessories, the present invention can also produce different functions to meet different needs. The following is a brief explanation:

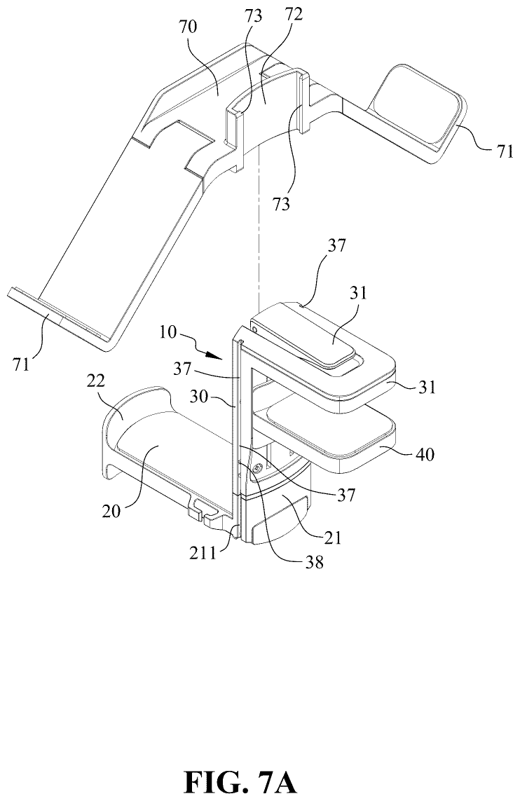

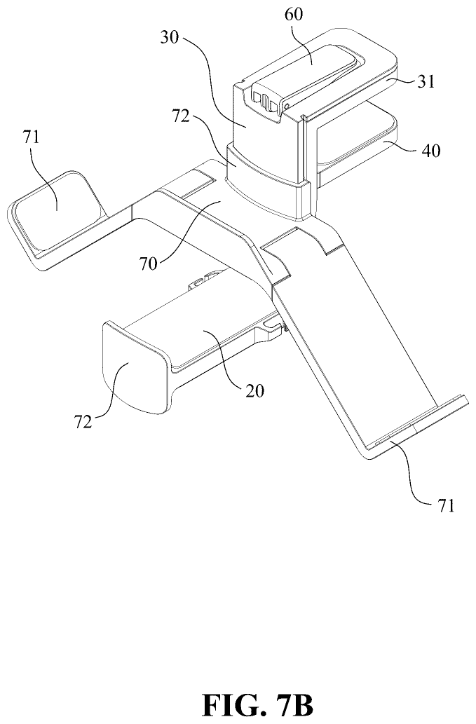

FIG. 7A and FIG. 7B are an exploded view and a perspective view of installing an auxiliary hanger on the present invention, respectively. As aforementioned, in the present invention, the two relatively narrow and opposite side walls of the shell 30 each have the first docking groove 37 in the longitudinal direction for installing accessories. In the present embodiment, the accessory is an auxiliary hanger 70. The auxiliary hanger 70 has two wings arranged in an inverted V shape. Both wings have upward hook pieces 71. The auxiliary hanger 70 also has a connecting piece 72. The connecting piece 72 has two longitudinal protruding docking pieces 73, and the docking pieces 73 are arranged face to face. The docking pieces 73 are inserted into the first docking groove 37 from top downwards, and stop when in contact with the stopper 38, so that the auxiliary hanger 70 can be fixed to the shell 30. The auxiliary hanger 70 increases the number of items that can be hung, and the remote controller of the video game can also be directly placed on it.

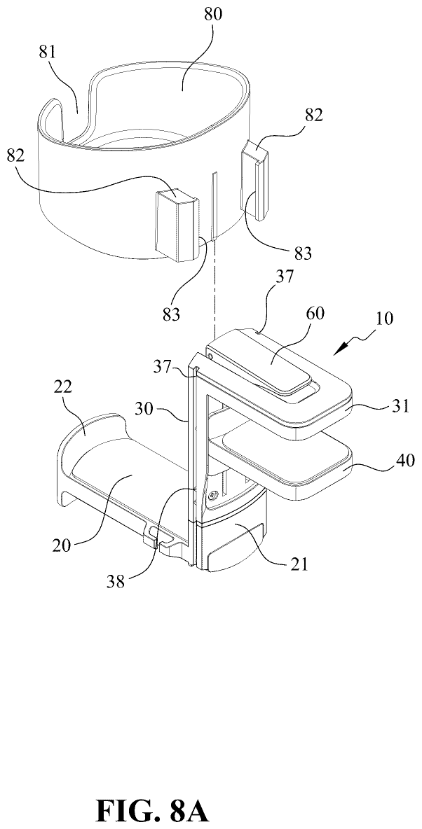

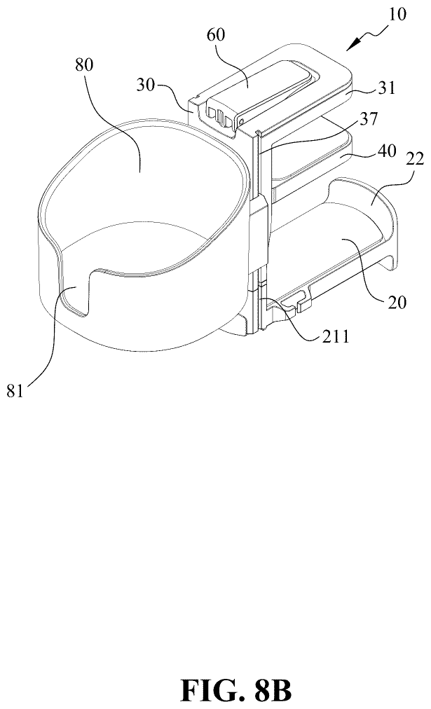

FIG. 8A and FIG. 8B are an exploded view and a perspective view of installing a cup holder on the present invention, respectively. The cup holder 80 is in a cylindrical shape with an opening facing upward, and has a notch 81 on the surrounding side wall. The notch 81 is a receiving position for the cup handle. The cup holder 80 also has a connecting piece 82. The connecting piece 82 has a longitudinally face-to-face protruding piece 83. The protruding piece 83 is inserted into the first docking groove 37 from top downwards, and stops when contacting the stopper 38, so that the cup holder 80 can be fixed on the shell 30 for a cup to be placed there. Of course, if the use of the cup holder 80 hinders the use of the load-bearing unit 20, as shown in FIG. 8B, the load-bearing unit 20 can be rotated 180 degrees to be located below the movable clamp arm 40.

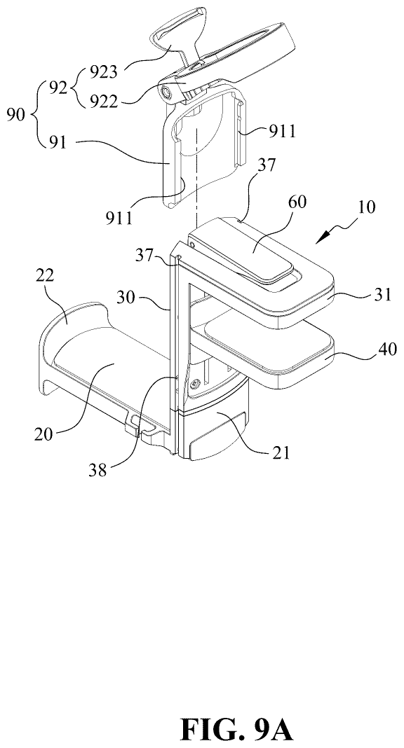

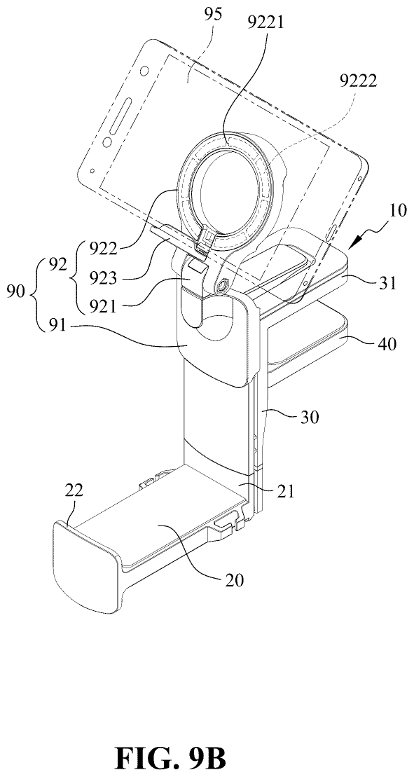

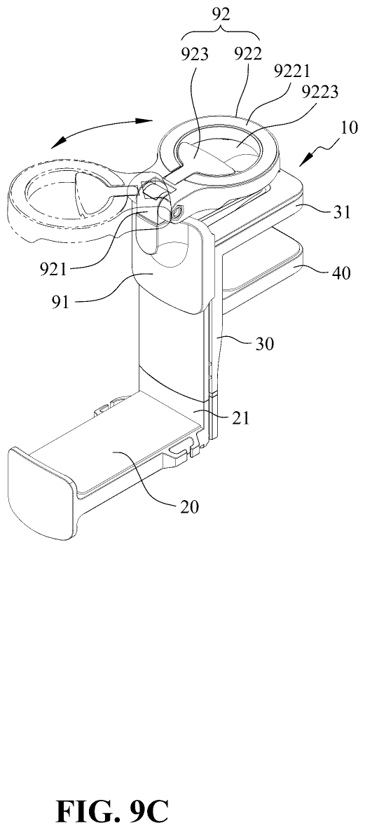

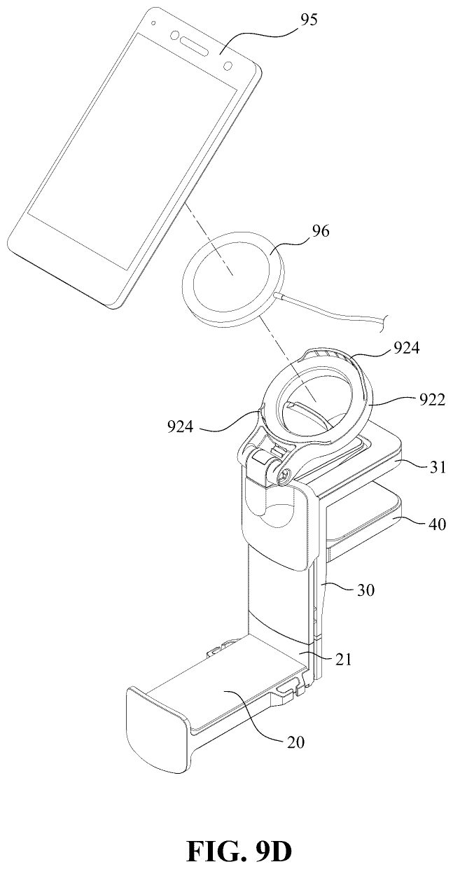

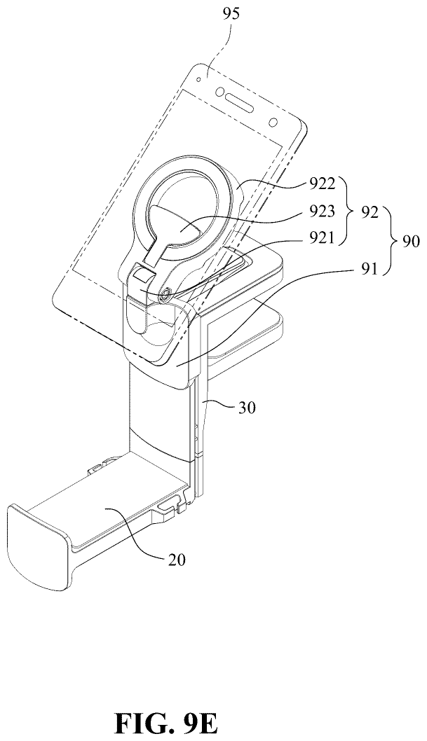

FIG. 9A and FIG. 9B are an exploded view and a perspective view of installing a hands-free support on the present invention, respectively. The hands-free support 90 includes a connecting piece 91 and a bracket assembly 92. The bracket assembly 92 can be used for the mobile phone 95 to be used in a hands-free manner. The bracket assembly 92 is rotatably coupled to the top of the connecting piece 91. As shown in FIG. 9A, the connecting piece 91 has a longitudinally facing convex piece 911. The convex piece 911 can be inserted into the first docking groove 37 from top downwards, so that the bracket assembly 92 can be fixed to the shell 30. The bracket assembly 92 is one of the embodiments of the present invention. The bracket assembly 92 includes a pivot member 921, a carrier member 922, and a stopper 923. The pivot member 921 is rotatably connected to the connecting member 91, as shown in FIG. 9C, the pivot member 91 can rotate around the connection joint. The pivot member 921 is pivotally connected to the carrier member 922, but the rotatable direction of the bearing member 922 is different from the rotation direction of the pivot member 921 and the connecting member 91. The load-bearing 922 has a flat surface 9221, and a local area of the surface 9221 is a magnetic attraction area 9222. A magnet (not shown in the figure) is provided inside the carrier member 922 where the magnetic attraction area 9222 is located, so that the magnetic attraction area 9222 is equipped with magnetic attraction. As shown in FIG. 9B, the stopper 923 is pivotally connected to the carrier member 922. When the stopper 923 is pulled up in a direction away from the carrier member 922, the stopper 923 will protrude from the surface 9221. In addition, the carrier member 922 is an annular structure, and has a penetrating space 9223 at the center. As shown in FIG. 9C, after the stopper 923 is pulled toward the carrier member 922, most of the structure of the stopper 923 can be located in the space 9223 and will not protrude from the surface 9221. As shown in FIG. 9D, the side of the carrier member 922 away from the stopper 923 has a surrounding wall 924, and the area enclosed by the surrounding wall 924 can be used for placing a wireless charging head 96.

As shown in FIG. 9B, the hands-free support 90 is fixed to the shell 30 of the clamping unit 10 with the connecting piece 91, and the carrier member 922 can be adjusted to be inclined, and utilizes the protruding stopper 923 of the surface 9221. When in use, the magnetic force generated by the magnetic area 9222 attracts the mobile phone 95, and the stopper 923 contacts the edge of the mobile phone 95 so that the mobile phone can be placed on the bracket assembly 92 in a hands-free manner. As shown in FIG. 9E, the mobile phone 95 is in an upright position for use. As shown in FIG. 9D, when the pivot member 921 and the carrier member 922 are rotated, the surrounding wall 924 of the carrier member 922 faces upward, so that the wireless charging head 96 can be placed in the space enclosed by the surrounding wall 924. When the wire of the wireless charging head 96 is connected to the power source, and the mobile phone 95 is placed on the wireless charging head 96, the charging operation can be performed.

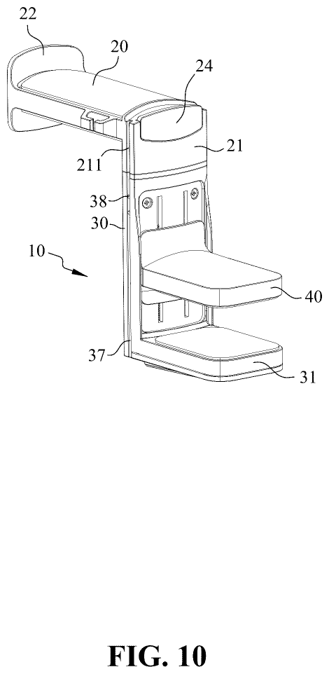

In the above embodiment, although the fixed clamp arm 31 and the movable clamp arm 40 are used to clamp a place to be fixed to, basically the fixed clamp arm 31 is at the top and the movable clamp arm 40 is at the bottom. But it is not limited herein. As shown in FIG. 10, FIG. 10 shows another usage method of the present embodiment. In the present embodiment, the movable clamp arm 40 is on the top and the fixed clamp arm 31 is on the bottom to achieve clamping.

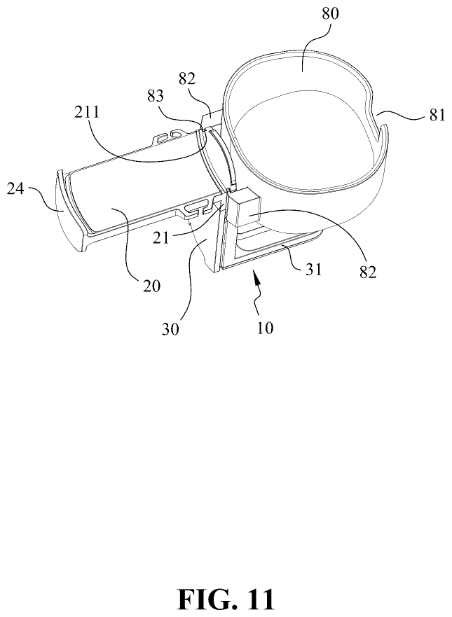

In the usage scenario of FIG. 10, the present invention can still install the aforementioned different accessories. FIG. 11 only provides one of the possibilities for illustration, and the others operate in the same way. As shown in FIG. 11, the cup holder 80 still has the connecting piece 82, but in the present embodiment, the connecting piece 82 is inserted into the second docking groove 211 from top to bottom with the protruding piece 83, and stops when in contact with the stopper 38, so that the cup holder 80 can also be fixed at the end portion 21.

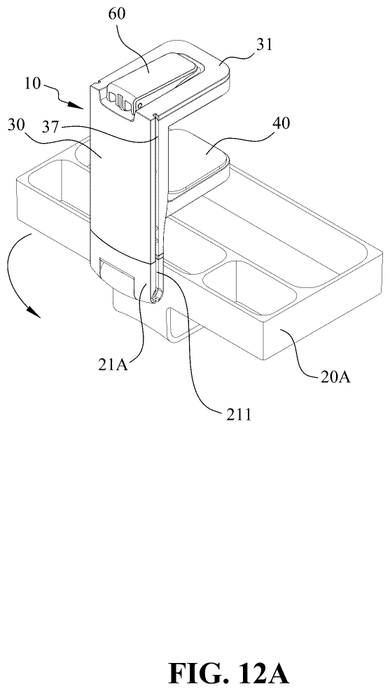

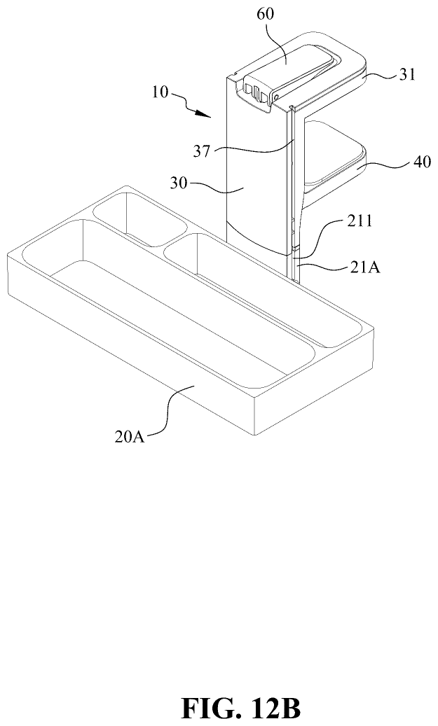

FIG. 12A and FIG. 12B show another embodiment of the present invention. In the present embodiment, the clamping unit 10 is similar to the above embodiment, with the difference that: the load-bearing unit 20A is of another type. In the present embodiment, the load-bearing unit 20A is a box with the opening facing upward. The space in the box is suitable for placing small items. The load-bearing unit 20A is still rotatably connected to the shell 30 by the end portion 21A. It can be seen from this embodiment that the load-bearing unit 20A of the present invention is not limited to a specific type, as long as it can carry items. In the present embodiment, the shell 30 also forms the first docking groove on both side walls 37, and the end portion 21 also forms the second docking groove 211 on both side walls.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A load-bearing structure with a clamp, comprising:
a clamping unit comprising:
a shell having a fixed clamp arm located at a first end of the shell and protruding from the shell,
a movable clamp arm configured to move along a side wall of the shell and configured to move towards or away from the fixed clamp arm,
a linkage component disposed in the shell, the linkage component for driving the movable clamp arm to move along the shell, and
a lever member located on a top surface of the fixed clamp arm and pivotally connected to the linkage component in the shell, the linkage component configured to drive the moveable clamp arm based on the lever member being flipped, and the lever member configured to shorten a clamping distance between the movable clamp arm and the fixed clamp arm based on the lever member being pressed down against the top surface of the fixed clamp arm; and
a load-bearing unit having an end portion, and the end portion rotatably connected to a second end of the shell away from the fixed clamp arm, the load-bearing unit configured to carry an item.

2. The load-bearing structure according to claim 1, wherein: the load-bearing unit is a long hollow shell.

3. The load-bearing structure according to claim 2, wherein: the load-bearing unit is further provided with an opening at the end portion and an extension hook, the extension hook inserted into the load-bearing unit through the opening, and the extension hook configured to partially pull out and protrude from the end portion without detaching from the load-bearing unit.

4. The load-bearing structure according to claim 1, wherein:
the linkage component comprises a screw rod and a moving member, the moving member installed in the shell, the moving member limited to linear movement, and the moving member driven to move based on the screw rod rotating;
the movable clamp arm engaged to the moving member, the moving member configured to drive the movable clamp arm toward or away from the fixed clamp arm; and
the screw rod extends through the fixed clamp arm with an exposed section of the screw rod pivotally connected with the lever member.

5. The load-bearing structure according to claim 4, wherein: the moving member is a rectangular frame with a screw nut fixed thereto, the screw nut is connected to the screw rod, the rectangular frame comprising a through groove, and a part of the through groove has a concave slot.

6. The load-bearing structure according to claim 5, wherein:
the movable clamp arm has a guide piece; and
the side wall of the shell has a longitudinal guide groove, and the guide piece penetrates into the shell through the longitudinal guide groove and is inserted into the through groove of the moving member.

7. The load-bearing structure according to claim 6, wherein: the guide piece has an elastic latch piece at a middle position, the elastic latch piece penetrates into the shell through the longitudinal guide groove, the elastic latch piece engaged to the concave slot of the moving member, and the movable clamp arm configured to move synchronously with the moving member.

8. The load-bearing structure according to claim 4, wherein: the lever member is pivotally connected to the screw rod with a pivot joint, the lever member has a first contact wall and a second contact wall perpendicular to the first contact wall, a first distance between the first contact wall and the pivot joint is less than a second distance between the second contact wall and the pivot joint, a position of the moving member is adjusted based on the lever member being pulled up to stand upright with the first contact wall in contact with the fixed clamp arm and the lever member being rotated, and the linkage component pulled up a preset distance to shorten the clamping distance based on the lever member being pulled downward with the second contact wall in contact with the fixed clamp arm.

9. The load-bearing structure according to claim 1, wherein: the shell comprises a first docking groove, and a stopper in the first docking groove.

10. The load-bearing structure according to claim 9, wherein: the end portion comprises a second docking groove, and the end portion configured to be adjusted to align the second docking groove to the first docking groove.

11. A load-bearing structure with a clamp, comprising:
a clamping unit, the clamping unit comprising:
a shell having a fixed clamp arm located at a first end of the shell and protruding from the shell, the shell being provided with a first docking groove and a stopper within the first docking groove,
a movable clamp arm configured to move along a side wall of the shell and configured to move towards or away from the fixed clamp arm,
a linkage component disposed in the shell, the linkage component comprising: a screw rod and a moving member installed at the screw rod, the moving member installed in the shell and limited to linear movement, the moving member driven to move based on the screw rod rotating, the movable clamp arm being engaged to the moving member, the moving member driving the movable clamp arm toward or away from the fixed clamp arm, and the screw rod extended through the fixed clamp arm, and
a lever member located on a top surface of the fixed clamp arm and pivotally connected to the linkage component in the shell, the linkage component configured to drive the movable clamp arm to move linearly based on the lever member being flipped, and the lever member configured to shorten a clamping distance between the movable clamp arm and the fixed clamp arm based on the lever member being pressed down against the top surface of the fixed clamp arm; and
a load-bearing unit having an end portion, the end portion rotatably connected to a second end of the shell away from the fixed clamp arm, the load-bearing unit configured to carry an item, the end portion provided with a second docking groove, the end portion configured to be adjusted aligning the second docking groove to the first docking groove.

12. The load-bearing structure according to claim 11, wherein the lever member is pivotally connected to the screw rod with a pivot joint, the lever member has a first contact wall and a second contact wall perpendicular to the first contact wall, a first distance between the first contact wall and the pivot joint is less than a second distance between the second contact wall and the pivot joint, a position of the moving member is adjusted based on the lever member being pulled up to stand upright with the first contact wall in contact with the fixed clamp arm and the lever member being rotated, and the linkage component being pulled up a preset distance to shorten the clamping distance based on the lever member being pulled downward placing the second contact wall in contact with the fixed clamp arm.

13. A method of manufacturing a load-bearing structure with a clamp, comprising:
forming a clamping unit comprising:
a shell having a fixed clamp arm located at a first end of the shell and protruding from the shell,
a movable clamp arm configured to move along a side wall of the shell and configured to move towards or away from the fixed clamp arm,
a linkage component disposed in the shell, the linkage component for driving the movable clamp arm to move along the shell, and
a lever member located on a top surface of the fixed clamp arm and pivotally connected to the linkage component in the shell, the linkage component configured to drive the moveable clamp arm based on the lever member being flipped, and the lever member configured to shorten a clamping distance between the movable clamp arm and the fixed clamp arm based on the lever member being pressed down against the top surface of the fixed clamp arm; and
rotatably connecting a load-bearing unit having an end portion to a second end of the shell away from the fixed clamp arm, the load-bearing unit configured to carry an item.

14. The method according to claim 13, wherein: rotatably connecting the load-bearing unit includes rotatably connecting a long hollow shell.

15. The method according to claim 14, wherein: rotatably connecting the load-bearing unit includes rotatably connecting the load-bearing unit further comprising an opening at the end portion and an extension hook, the extension hook inserted into the load-bearing unit through the opening, and the extension hook configured to partially pull out and protrude from the end portion without detaching from the load-bearing unit.

16. The method according to claim 13, wherein forming the clamping unit includes forming the clamping unit wherein:
the linkage component comprises a screw rod and a moving member, the moving member installed in the shell, the moving member limited to linear movement, and the moving member driven to move based on the screw rod rotating;
the movable clamp arm engaged to the moving member, the moving member configured to drive the movable clamp arm toward or away from the fixed clamp arm; and
the screw rod extends through the fixed clamp arm with an exposed section of the screw rod pivotally connected with the lever member.

17. The method according to claim 16, wherein: forming the clamping unit includes forming the clamping unit with the moving member being a rectangular frame with a screw nut fixed thereto, the screw nut is connected to the screw rod, the rectangular frame comprising a through groove, and a part of the through groove has a concave slot.

18. The method according to claim 17, wherein forming the clamping unit includes forming the clamping unit wherein:
the movable clamp arm has a guide piece; and
the side wall of the shell has a longitudinal guide groove, and the guide piece penetrates into the shell through the longitudinal guide groove and is inserted into the through groove of the moving member.

19. The method according to claim 18, wherein forming the clamping unit includes forming the clamping unit wherein: the guide piece has an elastic latch piece at a middle position, the elastic latch piece penetrates into the shell through the longitudinal guide groove, the elastic latch piece engaged to the concave slot of the moving member, and the movable clamp arm configured to move synchronously with the moving member.

20. The method according to claim 16, wherein forming the clamping unit includes forming the clamping unit wherein: the lever member is pivotally connected to the screw rod with a pivot joint, the lever member has a first contact wall and a second contact wall perpendicular to the first contact wall, a first distance between the first contact wall and the pivot joint is less than a second distance between the second contact wall and the pivot joint, a position of the moving member is adjusted based on the lever member being pulled up to stand upright with the first contact wall in contact with the fixed clamp arm and the lever member being rotated, and the linkage component pulled up a preset distance to shorten the clamping distance based on the lever member being pulled downward with the second contact wall in contact with the fixed clamp arm.
